(19) United States
(12) Patent Application Publication
(10) Pub. No.: US 2012/0086645 A1
(43) Pub. Date: Apr. 12, 2012

(54) EYE TYPING SYSTEM USING A THREE-LAYER USER INTERFACE

(75) Inventors: Xianjun S. Zheng, Plainsboro, NJ (US); Joeri Kiekebosch, Amsterdam (NL); Jeng-Weei James Lin, Princeton Junction, NJ (US); Stuart Goose, Berkeley, CA (US)

(73) Assignee: Siemens Corporation, Iselin, NJ (US)

(21) Appl. No.: 13/213,210

(22) Filed: Aug. 19, 2011

Related U.S. Application Data
(60) Provisional application No. 61/391,701, filed on Oct. 11, 2010.

(51) Int. Cl. G06F 3/02

(52) U.S. Cl. 345/168

(57) ABSTRACT

A specially-configured interactive user interface for use in eye typing takes the form of a three-layer arrangement that allows for controlling computer input with eye gazes. The three-layer arrangement includes an outer, rectangular ring of letters, displayed clockwise in alphabetical order (forming the first layer). A group of “frequently-used words” associated with the letters being typed forms an inner ring (and is defined as the second layer). This second layer of words is constantly updated as the user continues to enter text. The third layer is a central “open” portion of the interface and forms the typing space—the “text box” that will be filled as the user continues to type. A separate row of control/function keys (including mode-switching for upper case vs. lower case, numbers and punctuation) is positioned adjacent to the three-layer on-screen keyboard display.

### CROSS-REFERENCE TO RELATED APPLICATIONS

This application claims the benefit of U.S. Provisional Application No. 61/391,701, filed Oct. 11, 2010 and herein incorporated by reference.

### TECHNICAL FIELD

The present invention relates to a specially-configured graphical user interface for use in eye typing and, more particularly, to a three-layer user interface that allows for controlling computer input with eye gazes, while also minimizing user fatigue and reducing typing error.

### BACKGROUND OF THE INVENTION

Eye typing, which utilizes eye gaze input to interact with computers, provides an indispensable means for people with severe disabilities to write, talk and communicate. Indeed, it is natural to imagine using eye gaze as a computer input method for a variety of reasons. For example, research has shown that eye fixations are tightly coupled to an individual's focus of attention. Eye gaze input can potentially eliminate inefficiencies associated with the use of an “indirect” input device (such as a computer mouse) that requires hand-eye coordination (e.g., looking at a target location on a computer screen and then moving the mouse cursor to the target). Additionally, eye movements are much faster, and require less effort, than many traditional input methods, such as moving a mouse or joystick with your hand. Indeed, eye gaze input could be particularly beneficial for use with larger screen workspaces and/or virtual environments. Lastly and perhaps the most important reason for considering and improving the utilization of eye gaze input, is that under some circumstances other control methods, such as using a hand or voice, might not be applicable. For example, with physically disabled people, their eyes may be the only available input channel for interacting with a computer.

In spite of these benefits, eye gaze is not typically used as an input method for computer interaction. Indeed, there remain critical design issues that need to be considered before eye gaze can be used as an effective input method for eye typing. People direct and move their eyes to receive visual information from the environment. The two most typical eye movements are “fixation” and “saccade”. Fixation is defined as the length of time that the eye lingers at a location. In visual searching or reading, the average fixation is about 200-500 milliseconds (ms). Saccade is defined as the rapid movement of the eye, lasting about 20-100 ms, with a velocity as high as 500°/sec.

A typical eye typing system includes an eye tracking device and an on-screen keyboard interface (the graphical user interface, or GUI). The eye tracking device generally comprises a camera located near the computer that monitors eye movement and provides input information to the computer based on these movements. Typically, the device will track a user's point of gaze on the screen and send this information to a computer application that analyzes the data and then determines the specific “key” on the on-screen keyboard that the user is staring at and wants to select. Thus, to start typing, a user will direct his gaze at the “key” of interest on the on-board screen and confirm this selection by fixating on this key for some pre-determined time threshold (referred to as “dwell time”).

Most on-screen keyboards for eye typing utilize the standard QWERTY keyboard layout. While this keyboard is quite familiar to regular computer users, it may not be optimal for eye typing purposes. Inasmuch as some disabled users may not be adept at using a QWERTY keyboard in the first instance, modifying the keyboard layout to improve their user experience is considered to be a viable option.

Additionally, most of the current eye typing systems are configured such that the on-screen keyboard occupies the majority of the central portion of the screen. The typed content is displayed in a small region, typically above the on-screen keyboard along the upper part of the screen. This layout design does not consider a typical user's writing process. As illustrated in FIG. 1, a typical writing process includes a first step of “thinking” about what to write (shown as step 10 in FIG. 1), then selecting and typing a letter (step 12). After cycling through this process a number of times, a complete word is typed (step 14), and the process returns to think about the next word or words that need to be typed. Once the text is completed, the user will review and edit the typed content (step 16), then finally “finish” the typing process (step 18).

Prior art on-screen keyboard designs are configured to address only step 12—selecting and typing a letter—without considering the necessary support for the other steps in the process, and/or the transitions between these steps. For instance, inasmuch as the on-screen keyboard occupies the central area of the screen, it is difficult for the user to “think” about what to write next without unintentionally staring (gazing) at the keyboard. The user's eye gaze may then accidentally “select” one of the keys, which then needs to be deleted before any new letters are typed. Obviously, these tasks disrupt the natural flow of the thought process. Furthermore, the separation between the centrally-located on-screen keyboard and the ‘text box’ (generally in an upper corner of the screen) makes the transition to reviewing the typed content difficult, leading to eye fatigue on the part of the user.

Thus, despite decades of research in eye typing (which, for the most part, dealt with the hardware/electronics associated with implementing a system), there lacks a well-designed solution that optimizes the eye typing user experience, specifically to address the optimal graphical user interface employed during eye typing.

### SUMMARY OF THE INVENTION

The need remaining in the prior art is addressed by the present invention, which relates to a specially-configured graphical user interface for use in eye typing and, more particularly, to a three-layer graphical user interface (GUI) that allows for effective and efficient control of computer input with eye gazes, while also minimizing user fatigue and reducing typing error.

In particular, the inventive “three-layer” GUI, also referred to as an “on-screen keyboard”, includes an outer, rectangular ring of letters, displayed clockwise in alphabetical order (forming the first layer). A group of “frequently-used words” associated with the letters being typed forms an inner ring (and is defined as the second layer). This second layer of words is constantly updated as the user continues to enter text. The third layer is a central “open” portion of the interface and forms the typing space—the “text box” that will be filled as the user continues to type. A separate row of control/function keys (including mode-switching keys for upper case vs. lower case, numbers and punctuation) is positioned adjacent to the three-layer on-screen keyboard display.

In a preferred embodiment, the text box inner region also includes keys associated with a limited number of frequently-used control characters (for example “space” and “backspace”), to reduce the need for a user to search for these control functions.

The use of an alphabetical display of letters is considered to improve the efficiency of the eye typing system over the prior art used of the QWERTY keyboard. Additional features may include a “visual prompt” that highlights a key upon which the user's is gazing (which then starts an indication of “dwell time”). Other visual prompts, such as highlighting a set of likely letters that may follow the typed letter, may be incorporated in the arrangement of the present invention. Audio cues, such as a “click” on a selected letter, may also be incorporated in the eye typing system of the present invention.

As the text continues to be typed, the second tier group of frequently-used words will be updated accordingly, allowing for the user to select an appropriate word without typing each and every letter to include in the text. The words are also shown in alphabetical order to provide an efficient display.

Other and further aspects and features of the present invention will become apparent during the course of the following discussion and by reference to the accompanying drawings.

### BRIEF DESCRIPTION OF THE DRAWINGS

Referring now to the drawings,

FIG. 1 is a flowchart, diagramming the conventional writing process;

FIG. 2 is a screenshot of the three-layer on-screen keyboard user interface for eye typing in accordance with the present invention, this particular screenshot being the initial user interface before any typing has begun;

FIG. 3 is a second screenshot of the on-screen keyboard, in this case after the selection and typing of a first letter;

FIG. 4 is a following screenshot, showing the typing of a complete phrase;

FIG. 5 shows a screenshot of a “page view” feature of the present invention, showing the text box as enlarged and overlapping the keyboard portion of the GUI;

FIG. 6 illustrates an exemplary eye typing system of the present invention; and

FIG. 7 shows an alternative eye tracking device that may be used with the system of FIG. 6.

### DETAILED DESCRIPTION

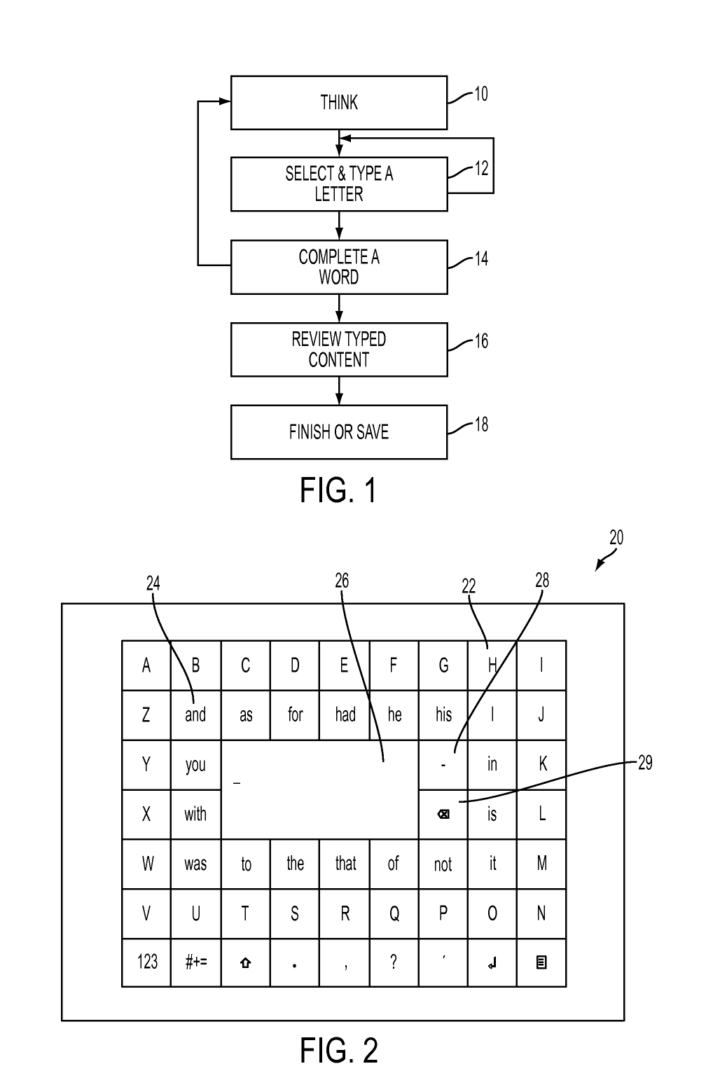

The inventive three-layer on-screen user interface suitable for eye typing is considered to address the various issues remaining in traditional on-screen QWERTY keyboards used for this purpose, with the intended benefits of supporting the natural workflow of writing and enhancing the overall user experience. As described in detail below, the novel arrangement comprises a three-layer disposition of functionality—(1) letters, (2) words and (3) typed text—that supports improved transitions between the various activities that occur during eye typing, as discussed above and shown in the flowchart of FIG. 1. The letters are selected from the outer ring, allowing for frequently-used words to be scanned in the inner ring, with the selected letter (or word) then appearing in the text box in the center.

Inasmuch as the letters and words are arranged alphabetically, a natural spatial proximity between the letters and words is created, allowing for a more efficient visual search for a target word. As also will be explained in more detail below, visual and audio feedback may be used to supplement the typing process, enhancing the overall eye typing experience.

FIG. 2 is a screenshot of the three-layer interactive on-screen keyboard 20 formed in accordance with the present invention. A first layer, defined as outer ring 22, includes in this particular example the standard 26-letter English alphabet, arranged alphabetically and moving clockwise from the upper left-hand corner. In this example, the letters “A”, “I”, “N” and “V” form the four corner letters, creating a rectangular “ring” structure. It is to be understood that in regions of the world where other alphabets are utilized, the keys would be modified to fit the alphabet (including the total number of alphabet/character keys included in the display).

The second tier of on-screen keyboard 20, defined as inner ring 24, is a set of constantly-updated “frequently used” words. In this particular example, a group of eighteen words is displayed, again in alphabetical order starting from the top, left-hand corner. The screenshot shown in FIG. 2 is an “initial” screen, before any typing has begun, and displays a general set of frequently-used words. In this example, inner ring 24 is populated by a set of eighteen frequently-used words, but the specific number of displayed words may be modified. The use of eighteen terms is considered preferred, however, and has been found to offer an abundance of word choices to the user without being overwhelming. Obviously, depending upon the specific use of the keyboard, these words in such a listing may be modified. For example, an elementary school student using the on-screen keyboard would likely be using different set of frequently-used words than a PhD student; a chemist may use a different set than an accountant. In addition, machine learning algorithms can be incorporated to learn the users' word usage preferences, thus improving the accuracy for the suggested words. It is a feature of the on-screen keyboard of the present invention that it can be easily adapted for use in a variety of different circumstances, requiring only minor software adaptations that can be introduced by the system developer or keyboard user. Moreover, as will be discussed below, the word list comprising inner ring 24 is itself constantly updated; as letters are typed, the word set will be updated to reflect the actual letters being typed.

The third layer of on-screen keyboard 20 comprises a central/inner region 26, which is the area where the typed letters will appear (referred to at times below as “text box 26”). In a preferred embodiment, a limited set of frequently-used function keys is included within inner region 26. In the specific embodiment illustrated in FIG. 2, a “space” key 28 and a “backspace” key 29 are shown. By placing the typed content in the central area of the screen, the user may easily review the content and ponder about what is to be typed next without fear of “accidently” or inadvertently selecting a key by gazing at the screen for an extended period of time (as was the case for prior art on-screen keyboard arrangements).

In a preferred embodiment of the present invention, on-screen keyboard 20 further comprises a row 30 of function keys, including a mode-switching functionality key (upper case vs. lower case), a numeric key, punctuation keys, and the like. Again, the specific keys included in this row of function keys may be adapted for different situations. In the specific arrangement shown in FIG. 2, row 30 is positioned below outer ring 22. Alternatively, row 30 may be displayed above outer ring 22, on either side of ring 22, or any combination thereof, allowing for flexible customization based upon a user's preferences.

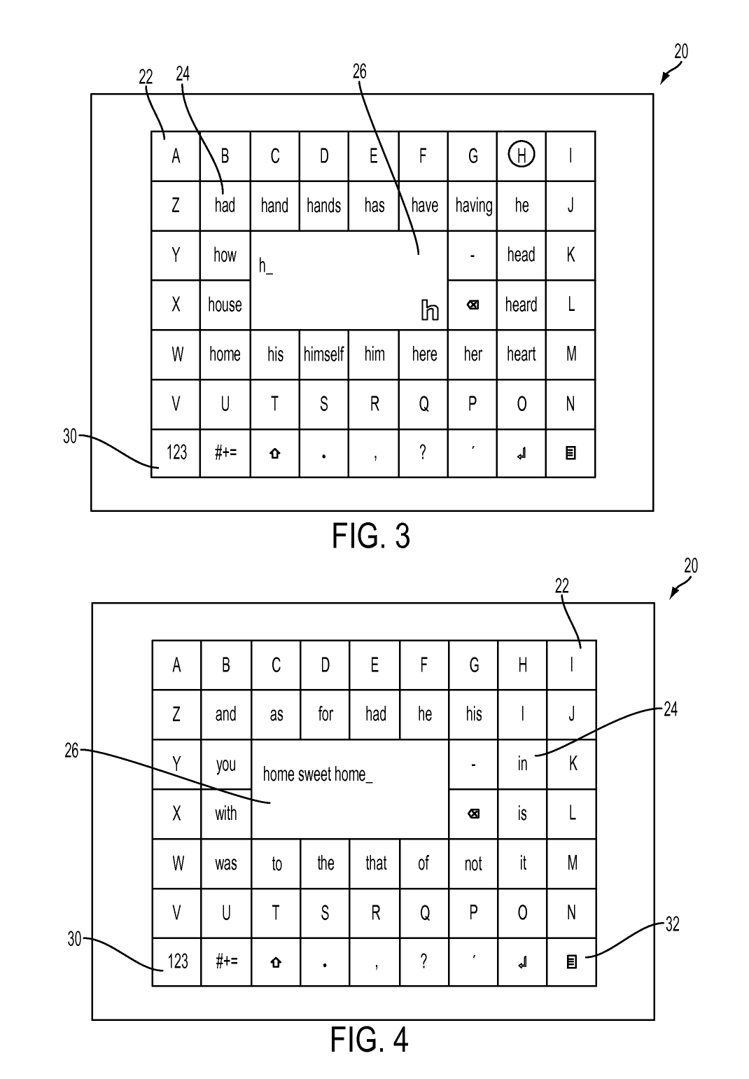

Similar to prior art eye typing arrangements, the system of the present invention uses dwell time to confirm a key selection. In one embodiment, “dwell time” can be visualized by using a running circle over the selected key. FIG. 3 illustrates this aspect of the present invention, where the user has gazed at the letter “h”. When the user fixates on this key, the circle will start (shown as circle 40 on letter “h” of outer ring 22). The user can easily cancel this action before the circle is completed by moving his gaze to another key before the circle is completed. Presuming in this case that the user desires to select the letter “h”, the circle will run until completed, based upon a predetermined dwell time threshold (e.g., 200 ms). When the circle is completed, additional confirmation of the selection of this letter can be provided by the “h” block changing color (visual confirmation), and/or a “clicking” (i.e., audio confirmation) may be supplied. The selected letter will then “fly” to central region (text box) 26. FIG. 3 illustrates the letter “h” as having been typed in text box 26.

While not required in a basic arrangement of the present invention, the addition of visual confirmation (such as color change) for a selected letter, with or without the utilization of an audio confirmation, is considered to enhance the user's experience, providing feedback and an affirmation to the user.

As shown in FIG. 3, the selection of the letter “h” has caused the frequently-used words within inner ring 24 to change, in this example to frequently-used words beginning with the letter “h”. Again, the words are arranged alphabetically, starting from the upper left-hand corner. Thus, the user can quickly scan these words and see if any are appropriate for his/her use. Since the initial “h” has already been typed, it is dimmed in the presentation of the frequently-used words. In one particular embodiment of this aspect of the present invention, this feature can be further modified by using two different luminance contrast levels for the words, based on their absolute frequency of use. The leading letters in all the words that are redundant with the already-typed text may be “dimmed” to provide an additional visual aid.

In an additional feature that may be employed in the system of the present invention, once a particular letter has been selected (in this example, “h”), a subset of other letters along outer ring 22 that may be used “next” are highlighted (or change in color—generally, made visually distinctive) to allow for the user to quickly and easily search and find the next letter s/he is searching for. Research has shown the positive effect of letter prediction on typing performance.

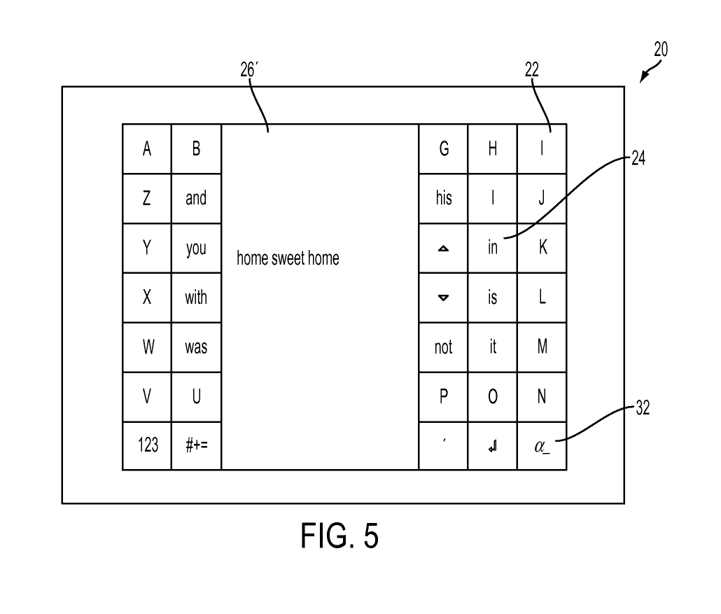

FIG. 4 is a screenshot of on-screen keyboard 20 of the present invention after a phrase has been eye typed by a user. As with the creation of any text document, as the number of lines of text continues to increase, the space devoted to text box 26 will begin to fill, and the earlier-typed lines will disappear from view. In a preferred embodiment of the present invention, function key row 30 includes a “page view” toggle key 32, which will bring up the current page of text being typed for review. FIG. 5 shows this aspect of the present invention, with text box 26 enlarged to “page” size and overlapping portions of outer ring 22 and inner ring 24. Preferably a pair of scroll keys (key 36 for “up” and key 38 for “down) are created with the page view mode, where the user can select either of these keys (using the same eye gaze/dwell control process) to move up and down the page. When in page mode, toggle key 32 will display “line view” mode and, upon selection by the user, will allow the display to revert to the form shown in FIG. 4.

In implementation, on-screen keyboard 20 of the present invention can be implemented using any appropriate programming language (such as, but not limited to, C#, Java or Action Script), or UI frameworks (such as Windows Presentation Foundation, Java Swing, Adobe Flex, or the like). One exemplary embodiment was developed using ActionScript 3.0 and run in the Adobe Flash Player and Air environment. The ActionScript 3.0 and Adobe Flex framework is considered useful for the development language in light of its powerful front-end capabilities (UI controls and visualization), as well as its system compatibility (i.e., applications are OS independent and can be run in any internet browser with Flash Player capability). This configuration is considered to be exemplary only, and does not limit the various environments within which the eye typing user interface of the present invention may be created.

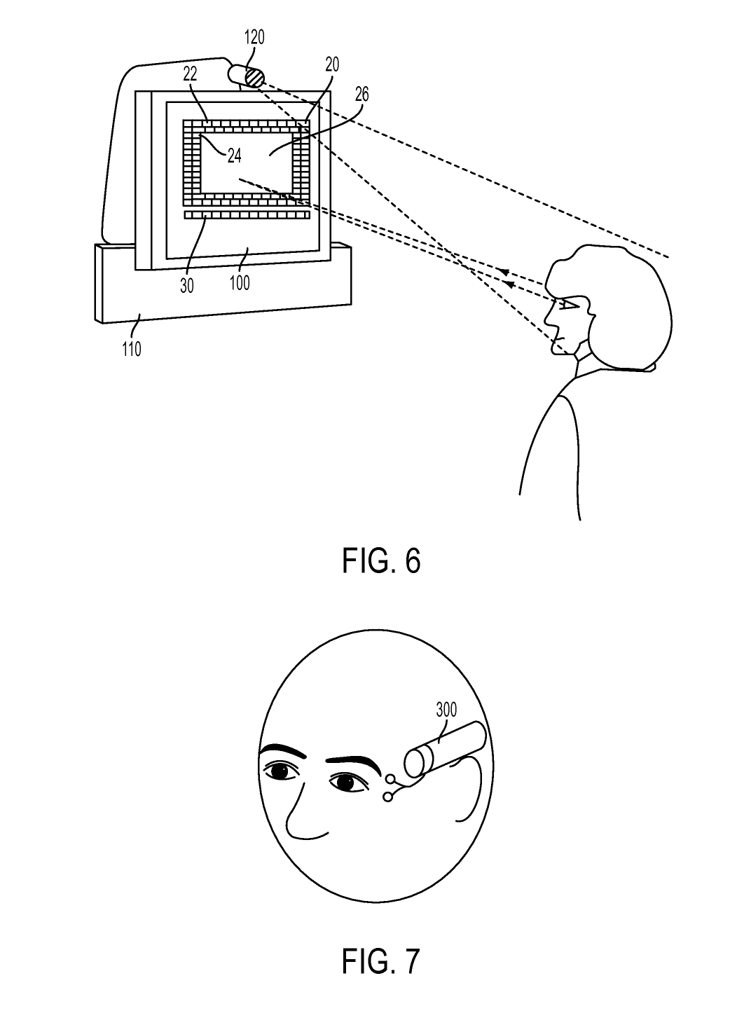

FIG. 6 illustrates an exemplary implementation of the present invention, where on-screen keyboard 20 is shown as the GUI on a computer monitor 100 associated with a desktop computer 110. An infrared camera 120 is mounted on monitor 100 and utilized to capture eye movements, feeding the data to an eye movement data processor included within computer 110. In some cases, or when used with certain laptop computer devices, camera 120 may take the form of a webcam integrated within the computer system. The data processor analyzes the eye gaze data input from camera 120 and determines which key of on-screen keyboard 20 the user wants to select, sending this information to the particular word processing program utilized by the system, with the selected letter then appearing in text box 26 of keyboard 20.

As an alternative to a computer-mounted camera, the eye tracking device may comprise an instrumentation 300 that is located with the user of the system, as shown in FIG. 7. In this case, the eye gaze data is from instrumentation 300 to the computer (preferably, over a wireless link). A standard hardware configuration used for this type of eye tracking (SMI iView X Red) utilizes the UPD protocol for data communications. Since the Adobe Flash application only supports the TCP/IP protocol, a middle communication layer needs to be configured (using, for example, Java and MySQL) to convert the UDP packages into TCP, or vice versa.

The eye typing system of the present invention is considered to be suitable for use with any interactive device including a display, camera and eye tracking components. While shown as a “computer” system, various types of personal devices include these elements and may utilize the eye typing system of the present invention.

Indeed, while the foregoing disclosure shows and describes a number of illustrative embodiments of the present invention, it will be apparent to those skilled in the art that various changes and modifications can be made herein without departing from the scope of the invention as defined by the claims appended hereto.

What is claimed is:

1. An eye typing system comprising
an eye tracking device for monitoring the movements of an eye, including gaze, fixation and saccade;
a display apparatus including an on-screen keyboard user interface configured as a three-layer arrangement comprising an outer ring of alphabet characters, an inner ring of frequently-used words and a central region for displaying typed text; and
a computer processor responsive to the eye tracking device for analyzing eye gaze and fixation data and determining which key of the on-screen keyboard user interface an individual has selected by eye movement, the letter or word associated with the selected key being displayed in the central region.

2. The eye typing system as defined in claim 1 wherein the on-screen keyboard user interface includes a row of function/control keys.

3. The eye typing system as defined in claim 2 where the row of function/control keys is displayed below the three-layer arrangement of the on-screen keyboard user interface.

4. The eye typing system as defined in claim 2 where the row of function/control keys is displayed above the three-layer arrangement of the on-screen keyboard user interface.

5. The eye typing system as defined in claim 2 where the row of function/control keys is displayed along one side of the three-layer arrangement of the on-screen keyboard user interface.

6. The eye typing system as defined in claim 1 where the outer ring of the three-layer arrangement of the on-screen keyboard user interface is disposed in a rectangular form, the first letter in the alphabet located in the upper left-hand corner of the rectangular form and proceeding clockwise.

7. The eye typing system as defined in claim 1 wherein the system further comprises visual confirmation of a user-selected letter in the outer ring.

8. The eye typing system as defined in claim 7 where the visual confirmation comprises a running circle overlying a letter upon which a user is gazing, where the circle runs for the duration of a predetermined dwell time and confirms letter selection at the completion of the dwell time interval.

9. The eye typing system as defined in claim 7 wherein the visual confirmation comprises a change in color or luminance of a letter upon which a user is gazing.

10. The eye typing system as defined in claim 1 wherein the system further comprises audio confirmation of user-selected letter in the outer ring.

11. The eye typing system as defined in claim 10 where the audio confirmation comprises a “click” upon completion of a predetermined dwell time interval.

12. The eye typing system as defined in claim 1 wherein the system further comprises letter prediction upon completion of letter selection.

13. The eye typing system as defined in claim 12 where letter prediction comprises a visual modification to a subset of letters predicted to follow a typed letter.

14. The eye typing system as defined in claim 13 where the visual modification comprises a change in color.

15. The eye typing system as defined in claim 13 where the visual modification comprises a change in luminance.

16. The eye typing system as defined in claim 1 where the inner ring of the three-layer arrangement of the on-screen keyboard user interface is disposed in a rectangular form, the first word in the constantly-updated frequently-used listing of words located in the upper left-hand corner of the rectangular form and proceeding clockwise in alphabetical order.

17. The eye typing system as defined in claim 16 wherein the listing of frequently-used words is updated as a letter or word is selected by the user.

18. The eye typing system as defined in claim 1 where the central area includes a set of common control function keys that may be selected using eye gaze by the user.

19. The eye typing system as defined in claim 1 wherein the system further comprises a control key to switch into a page view format such that the central region displays a page of text and overlaps the outer and inner rings of the three-layer on-screen keyboard user interface.

20. A method of eye typing using gaze, fixation and saccade attributes of eye movement, the method comprising the steps of:
providing a display apparatus with an on-screen keyboard user interface configured as a three-layer arrangement comprising an outer ring of alphabet keys, an inner ring of frequently-used words and a central region for displaying typed text;
monitoring a user's eye movements with an eye tracking device;
analyzing eye gaze and fixation as a user is viewing the on-screen keyboard user interface; and
determining a selected key from the keyboard upon fixation for a predetermined period of time; and
displaying the selected key in the central region of the on-screen keyboard user interface.
